(19) United States
(12) Patent Application Publication
(10) Pub. No.: US 2003/0231417 A1
(43) Pub. Date: Dec. 18, 2003

(54) Method for initializing magnetic recording medium, method for transferring signal to magnetic recording medium, apparatus for processing signal of magnetic recording medium and double-sided perpendicular magnetic recording medium

(75) Inventors: Shingo Hamaguchi, Kawasaki (JP); Kazuyuki Ozaki, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/375,751

(22) Filed: Feb. 26, 2003

(30) Foreign Application Priority Data
Jun. 14, 2002 (JP) 2002-174774

(51) Int. Cl. G11B 5/86

(52) U.S. Cl. 360/17

(57) ABSTRACT

An initialization magnetic field Hi as an external magnetic field is applied in a direction crossing (perpendicularly) the surface of the substrate 10 to initialize the medium 1, so that the first magnetic film 11 and the second magnetic film 12 can be initialized simultaneously. In this method for initializing a medium, the magnetization direction of the initialization magnetization H1i at the first magnetic film 11 and the magnetization direction of the initialization magnetization H2i at the second magnetic film 12 accord with each other with regard to a direction crossing the substrate 10.

### BACKGROUND OF THE INVENTION

1. Field of the Invention

The present invention relates to a method for initializing a magnetic recording medium, a method for transferring a signal to a magnetic recording medium, an apparatus for processing a signal of a magnetic recording medium and a double-sided perpendicular magnetic recording medium.

2. Description of Related Art

A double-sided perpendicular magnetic recording medium (which is also simply called a “medium” hereinafter) is known, which records information as perpendicular magnetization in each of magnetic films formed on both sides of a substrate. Such a medium is used for a mass storage such as a hard disk.

FIGS. 1A and 1B are explanatory views for showing magnetization states of a conventional medium. FIG. 1A shows a magnetization state of an initialized medium, and FIG. 1B shows a magnetization state of a medium having signals recorded therein. In FIGS. 1A and 1B, a medium 1 is composed of a substrate 10, a first magnetic film 11 and a second magnetic film 12. The substrate 10 is made of a non-magnetic material and has flat faces. The material of the substrate 10 is, for example, glass, synthetic resin such as polycarbonate, metal such as aluminum, silicon, carbon or the like. The first magnetic film 11 is formed on a first surface of the substrate 10, while the second magnetic film 12 is formed on a second surface of the substrate 10 on the other side of 10 the first surface. The material of the first magnetic film 11 and the second magnetic film 12 is selected from various kinds of magnetic materials, such as TbFeCo, TbFe, TbCo, GdFeCo, DyFeCo, FePt, Co/Fe and Co/Pd. It should be noted that the first magnetic film 11 and the second magnetic film 12 have perpendicular magnetic anisotropy wherein a magnetization direction thereof accords with a perpendicular direction of the substrate 10.

Arrows H1i and H2i in FIG. 1A respectively indicate magnetization of the initialized first magnetic film 11 and magnetization of the initialized second magnetic film 12, i.e., initialization magnetization of the first and second magnetic films 11 and 12. Fletching marks H1 and H2 respectively indicate the magnetization direction at the surface of the first magnetic film 11 and the magnetization direction at the surface of the second magnetic film 12 when the surface is seen from the outside of the medium 1. The magnetization direction of the initialization magnetization H1i and H2i cross (perpendicularly) the surface of the substrate 10 from the outside to the inside of the medium 1, and accord with each other when the surface of the medium 1 is seen from the outside of the medium 1, as indicated by the surface magnetization directions H1 and H2. In other words, with regard to a direction perpendicular to the surface of the substrate 10, the direction of the initialization magnetization H1i of the first magnetic film 11 is opposite to the direction of the initialization magnetization H2i of the second magnetic film 12.

Arrows H1m and H2m relieved in white in FIG. 1B (mark magnetization H1m and H2m) respectively indicate a state where signals (which are also called marks hereinafter) are recorded in the first magnetic film 11 and a state where signals (marks) are recorded in the second magnetic film 12. In other words, the mark magnetization H1m and H2m indicates a state where marks are recorded by generating magnetization in a direction opposite to the initialization magnetization H1i and H2i. The mark magnetization H1m and H2m is also directed in a direction opposite to the initialization magnetization H1i and H2i with regard to the surface magnetization directions H1 and H2.

FIG. 2 is an explanatory view for showing a conventional method for initializing a medium. Like codes are used to refer to like parts in FIGS. 1A and 1B, and explanation thereof is omitted here. In FIG. 2, a magnet MG generates magnetic field lines ML for magnetizing only a magnetic film which the magnet faces. When the magnet MG scans over the surface of the medium 1 in a direction indicated by an arrow A, the magnetic field lines ML initialize the first magnetic film 11 and the second magnetic film 12 individually, to form initialization magnetization H1i and H2i respectively in the first magnetic film 11 and the second magnetic film 12. FIG. 2 shows a state where initialization of the second magnetic film 12 to form the initialization magnetization H2i is completed and it is in the middle of initialization of the first magnetic film 11 to form the initialization magnetization H1i. By such an initialization method, the initialization magnetization H1i and H2i is formed so as to be directed in directions opposite to each other with regard to a perpendicular direction of the substrate 10. Such a conventional initialization method, wherein the first magnetic film 11 and the second magnetic film 12 of the medium 1 are initialized individually, requires a lot of time for initialization. It should be noted that the initialization magnetization H1i and H2i is directed in different directions but has the same magnitude.

As described above, a conventional medium has a problem that initialization thereof is difficult and time consuming.

### BRIEF SUMMARY OF THE INVENTION

The present invention has been made with the aim of solving the above problem, and it is an object thereof to provide a method for initializing a magnetic recording medium whereby a direction of initialization magnetization formed on one side of a substrate and a direction of initialization magnetization formed on the other side of the substrate accord with each other with regard to a direction crossing the surface of the substrate.

Another object of the invention is to provide a method for initializing a magnetic recording medium whereby a plurality of double-sided perpendicular magnetic recording mediums can be initialized simultaneously.

Another object of the invention is to provide a method for transferring a signal to a magnetic recording medium whereby a signal pattern (such as a pre-format signal) can be transferred to a slave medium easily and precisely.

Another object of the invention is to provide an apparatus for processing a signal of a magnetic recording medium, which can easily write/read a signal onto/from a double-sided perpendicular magnetic recording medium in which a direction of initialization magnetization of a magnetic film formed on one side of a substrate and a direction of initialization magnetization of a magnetic film formed on the other side of the substrate accord with each other with regard to a direction crossing the surface of the substrate.

Still another object of the invention is to provide a double-sided perpendicular magnetic recording medium in which a direction of initialization magnetization of a magnetic film formed on one side thereof and a direction of initialization magnetization of a magnetic film formed on the other side thereof accord with each other with regard to a perpendicular direction thereof.

A method for initializing a magnetic recording medium according to the present invention is a method for initializing a double-sided perpendicular magnetic recording medium, which comprises: a substrate; a first magnetic film formed on a first surface of the substrate; and a second magnetic film formed on a second surface of the substrate on the other side of the first surface. In this method for initializing a magnetic recording medium, an initialization magnetic field is applied in a direction crossing the surface of the substrate to initialize the first magnetic film and the second magnetic film simultaneously. A direction of initialization magnetization of the first magnetic film and a direction of initialization magnetization of the second magnetic film accord with each other with regard to the direction crossing the surface of the substrate.

By this method for initializing a magnetic recording medium in which an initialization magnetic field is applied in a direction crossing the surface of the substrate so that a direction of initialization magnetization of the first magnetic film and a direction of initialization magnetization of the second magnetic film accord with each other with regard to the direction crossing the substrate, the first magnetic film and the second magnetic film can be initialized simultaneously. Accordingly, the double-sided perpendicular magnetic recording medium can be initialized easily and precisely, time required for initialization can be reduced, and the efficiency of medium initialization can be enhanced.

In the method for initializing a magnetic recording medium according to the present invention, a plurality of double-sided perpendicular magnetic recording mediums may be superposed and the initialization magnetic field may be then applied in the superposition direction so as to initialize the double-sided perpendicular magnetic recording mediums simultaneously.

By this method for initializing a magnetic recording medium, double-sided perpendicular magnetic recording mediums can be initialized easily, time required for initialization can be reduced, and the efficiency of medium initialization can be significantly enhanced.

A method for transferring a signal to a magnetic recording medium according to the present invention is a method for transferring a signal pattern to a double-sided perpendicular magnetic recording medium, which comprises: a substrate; a first magnetic film formed on a first surface of the substrate; and a second magnetic film formed on a second surface of the substrate on the other side of the first surface. This method for transferring a signal to a magnetic recording medium comprises: a step of arranging a first master medium having a magnetic material area corresponding to a signal pattern to be transferred in contact with or in proximity to the first magnetic film and arranging a second master medium having a magnetic material area corresponding to a signal pattern to be transferred in contact with or in proximity to the second magnetic film; and a step of applying a magnetic field for signal transfer in a direction crossing the first master medium, double-sided perpendicular magnetic recording medium and second master medium, to transfer the signal pattern of the first master medium to the first magnetic film and the signal pattern of the second master medium to the second magnetic film.

In the method for transferring a signal to a magnetic recording medium according to the present invention, the double-sided perpendicular magnetic recording medium may be such initialized in advance that-a direction of initialization magnetization of the first magnetic film and a direction of initialization magnetization of the second magnetic film accord with each other with regard to a direction crossing the surface of the substrate.

In the method for transferring a signal to a magnetic recording medium according to the present invention, the magnetic material area may be made of soft magnetic material or perpendicular ferromagnetic material.

In the method for transferring a signal to a magnetic recording medium according to the present invention, each one of the signal pattern in the first master medium and the signal pattern in the second master medium may be a mirror image of the other.

In the method for transferring a signal to a magnetic recording medium according to the present invention, the signal pattern to be transferred may be a pattern of a pre-format signal of the double-sided perpendicular magnetic recording medium.

In these methods for transferring a signal to a magnetic recording medium according to the present invention, in which a first master medium is arranged to face the first magnetic film of the double-sided perpendicular magnetic recording medium (slave medium) and a second master medium is arranged to face the second magnetic film before a magnetic field for signal transfer is applied in a direction crossing the surface of the slave medium, initialization of the signal pattern (mark pattern) of the first master medium to the first magnetic film and initialization of the signal pattern (mark pattern) of the second master medium to the second magnetic film are performed simultaneously. Accordingly, signals can be transferred from master mediums to a slave medium easily and precisely.

An apparatus for processing a signal of a magnetic recording medium according to the present invention comprises at least one of signal write means for writing a signal in a first magnetic film and a second magnetic film which are formed on respective sides of a double-sided perpendicular magnetic recording medium; and signal read means for reading signals from the first magnetic film and the second magnetic film. In the double-sided perpendicular magnetic recording medium, a direction of initialization magnetization of the first magnetic film and a direction of initialization magnetization of the second magnetic film accord with each other with regard to a direction crossing the surface of the substrate. The signal write means includes an inversion circuit for inverting polarity of any one of a signal to be written in the first magnetic film and a signal to be written in the second magnetic film, and the signal read means includes an inversion circuit for inverting polarity of any one of a signal read from the first magnetic film and a signal read from the second magnetic film.

In this apparatus for processing a signal of a magnetic recording medium, the signal read means includes an inversion circuit for inverting polarity of any one of a signal read from the first magnetic film and a signal read from the second magnetic film, and the signal write means includes an inversion circuit for inverting polarity of any one of a signal to be written in the first magnetic film and a signal to be written in the second magnetic film. Accordingly, signals can be written/read easily and precisely in/from the double-sided perpendicular magnetic recording medium in which a direction of initialization magnetization of the first magnetic film and a direction of initialization magnetization of the second magnetic film accord with each other with regard to a direction crossing the substrate.

A double-sided perpendicular magnetic recording medium according to the present invention comprises: a substrate; a first magnetic film formed on a first surface of the substrate; and a second magnetic film formed on a second surface of the substrate on the other side of the first surface. A direction of initialization magnetization of the first magnetic film and a direction of initialization magnetization of the second magnetic film accord with each other with regard to a direction crossing the surface of the substrate.

With this double-sided perpendicular magnetic recording medium in which a direction of initialization magnetization of the first magnetic film and a direction of initialization magnetization of the second magnetic film accord with each other with regard to a direction crossing the substrate, time and labor required for initialization can be reduced, and thereby a medium can be prepared at small cost.

The above and further objects and features of the invention will more fully be apparent from the following detailed description with accompanying drawings.

### BRIEF DESCRIPTION OF THE SEVERAL VIEWS OF THE DRAWINGS

FIGS. 1A and 1B are explanatory views for showing magnetization states of a conventional medium;

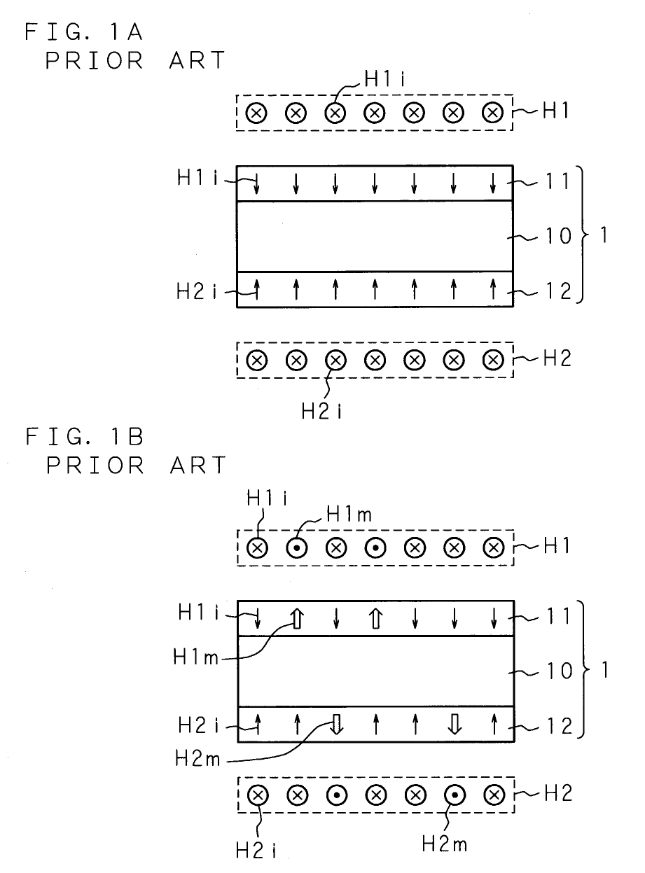

FIG. 2 is an explanatory view for showing a conventional method for initializing a medium;,

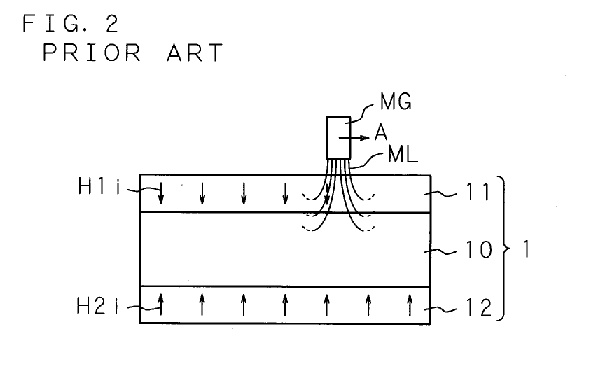

FIGS. 3A and 3B are explanatory views for showing a method for initializing a medium according to the present invention and magnetization states;

FIG. 4 is an explanatory view for showing a method for initializing a medium according to the present invention;

FIGS. 5A through 5C are explanatory views for showing a method for transferring a signal to a medium according to the present invention;

FIGS. 6A through 6C are explanatory views for showing another method for transferring a signal to a medium to be compared with the method for transferring a signal to a medium shown in FIGS. 5A through 5C;

FIGS. 7A through 7C are explanatory views for showing transfer states of cylinder numbers at a magnetic disk to which the present invention has been applied; and

FIG. 8 is a schematic view of an apparatus for processing a signal of a medium according to the present invention.

### DETAILED DESCRIPTION OF THE INVENTION

The following description will explain the present invention in detail with reference to the drawings illustrating some embodiments thereof.

First Embodiment

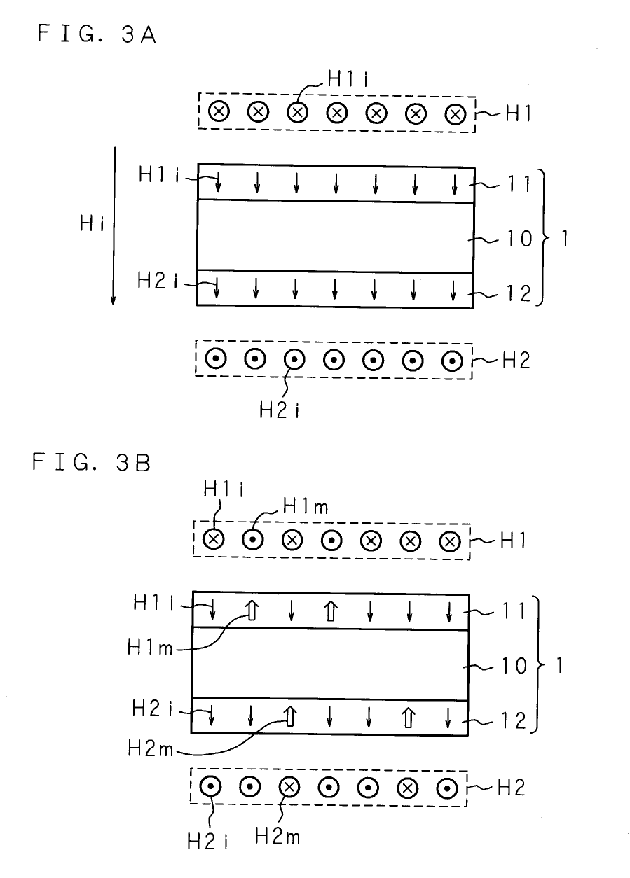

FIGS. 3A and 3B are explanatory views for showing a method for initializing a medium according to the present invention and magnetization states. FIG. 3A shows a magnetization state of an initialized medium, and FIG. 3B shows a magnetization state of a medium having signals recorded therein. In FIGS. 3A and 3B, a medium 1 is composed of a substrate 10, a first magnetic film 11 and a second magnetic film 12. The substrate 10 is made of a non-magnetic material such as the material used in the prior art, and has flat faces. The thickness of the substrate 10 is 100 μm to 1 mm. By a conventional film forming method, the first magnetic film 11 is formed on a first surface of the substrate 10 while the second magnetic film 12 is formed on a second surface of the substrate 10 on the other side of the first surface. The first magnetic film 11 and the second magnetic film 12 are made of a magnetic material such as the material used in the prior art, and the thickness thereof is, for example, several nanometers to several tens nanometers. It should be noted that the first magnetic film 11 and the second magnetic film 12 have perpendicular magnetic anisotropy wherein a magnetization direction thereof accords with a perpendicular direction of the substrate 10.

In FIG. 3A, an initialization magnetic field Hi as an external magnetic field is applied in a direction crossing (perpendicularly) the surface of the substrate 10 which is disposed between an N pole portion and an S pole portion, to initialize the medium 1. The initialization magnetic field Hi is applied through the medium 1 in a direction crossing the surface of the medium 1. Accordingly, the first magnetic film 11 and the second magnetic film 12 are simultaneously initialized in the same direction, with regard to a direction crossing the substrate 10. Arrows H1i and H2i respectively indicate magnetization of the initialized first magnetic film 11 and magnetization of the initialized second magnetic film 12, i.e., initialization magnetization of the first and second magnetic films 11 and 12. Fletching marks H1 and H2 respectively indicate the magnetization direction at the surface of the first magnetic film 11 and the magnetization direction at the surface of the second magnetic film 12 when the surface is seen from the outside of the medium 1. The magnetization direction of the initialization magnetization H1i crosses perpendicularly the surface of the substrate 10 from the outside to the inside of the medium 1. When the surface of the medium 1 (first magnetic film 11) is seen from the outside of the medium 1, the magnetization direction of the initialization magnetization H1i is directed from the front side to the back face of the medium 1 and is illustrated with x-ed circles indicated by the surface magnetization direction H1 in the figures. The magnetization direction of the initialization magnetization H2i crosses perpendicularly the surface of the substrate 10 from the inside to the outside of the medium 1. When the surface of the medium 1 (second magnetic film 12) is seen from the outside of the medium 1, the magnetization direction of the initialization magnetization H2i is directed from the back face of the medium 1 to the front side thereof and is illustrated with dotted circles indicated by the surface magnetization direction H2 in the figures. In other words, in the method for initializing the medium 1, the initialization magnetization H1i of the first magnetic film 11 and the initialization magnetization H2i of the second magnetic film 12 are simultaneously formed in the same direction with regard to a perpendicular direction of the substrate 10. Consequently, time and labor required for initialization can be reduced.

Arrows H1m and H2m relieved in white in FIG. 3B respectively indicate a state where a signal (mark) is recorded in the first magnetic film 11 and a state where a signal (mark) is recorded in the second magnetic film 12 (mark magnetization H1m and H2m). In other words, the mark magnetization H1m and H2m indicates a state where signals are recorded by generating magnetization in directions respectively opposite to the initialization magnetization H1i and H2i. The mark magnetization H1m and H2m is also directed in directions respectively opposite to the initialization magnetization H1i and H2i with regard to the surface magnetization directions H1 and H2. Consequently, with regard to a perpendicular direction of the substrate 10, the direction of the mark magnetization H1m of the first magnetic film 11 and the direction of the mark magnetization H2m of the second magnetic film 12 accord with each other.

Second Embodiment

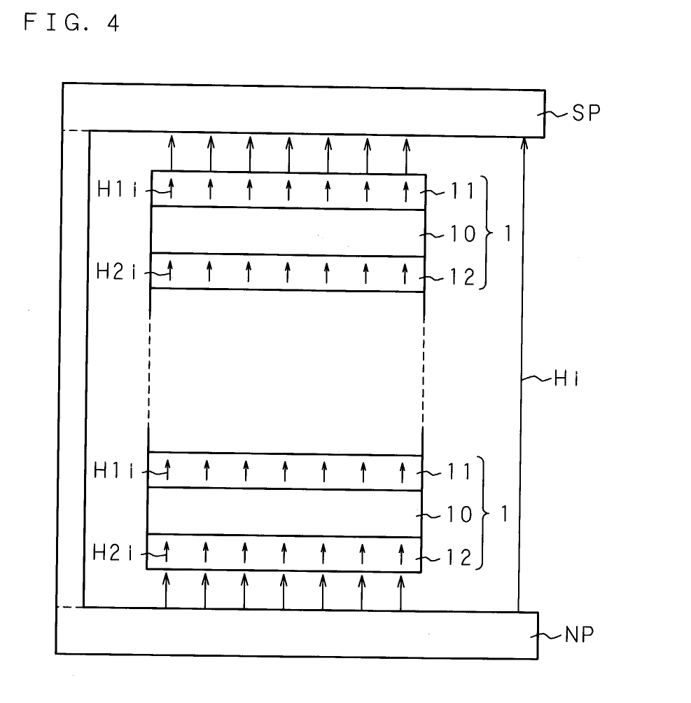

FIG. 4 is an explanatory view for showing a method for initializing a medium according to the present invention. A plurality of mediums 1, each of which is composed of a substrate 10, a first magnetic film 11 and a second magnetic film 12, are disposed in piles between an N pole portion NP and an S pole portion SP. An initialization magnetic field H1 as an external magnetic field is then applied in a perpendicular direction of the substrate (superposition direction) of the substrate 10 for performing initialization. By this method, a plurality of superposed mediums 1 can be initialized simultaneously, and moreover, the state of the initialization magnetization (H1i and H2i) of each medium 1 can be uniform with high accuracy. Consequently, significantly high efficiency of initialization of a medium 1 can be realized. Here, a method for initializing a plurality of mediums 1 simultaneously is realized because each medium is such initialized that the direction of the initialization magnetization H1i of the first magnetic film 11 and the direction of the initialization magnetization H2i of the second magnetic film 12 accord with each other, with regard to a perpendicular direction of the substrate 10. Moreover, with regard to a perpendicular direction of the substrate 10, the direction of the mark magnetization H1m (in FIG. 3B) which indicates magnetization of a signal in the first magnetic film 11 and the direction of the mark magnetization H2m (in FIG. 3B) which indicates magnetization of a signal in the second magnetic film 12 accord with each other.

Third Embodiment

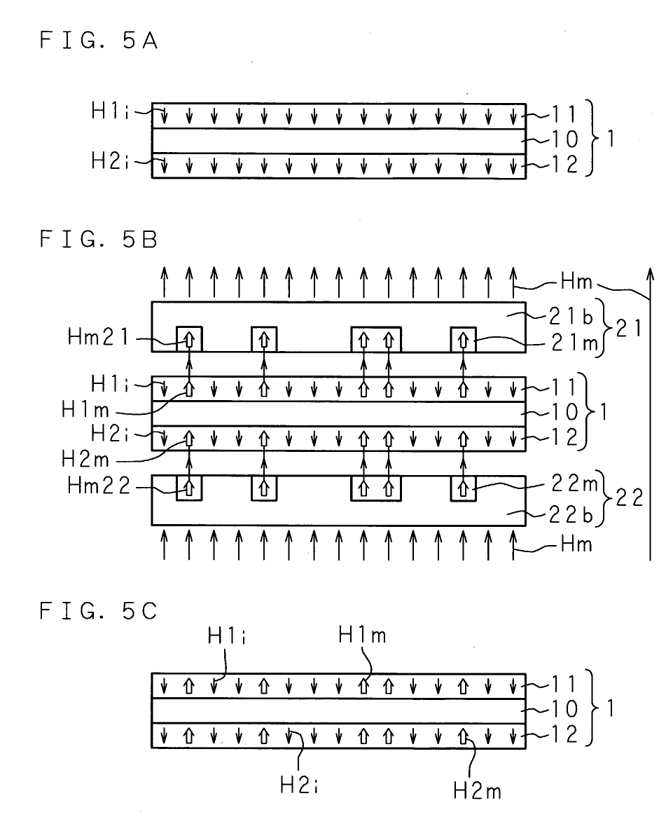

FIGS. 5A through 5C are explanatory views for showing a method for transferring a signal to a medium according to the present invention. FIG. 5A shows a magnetization state of an initialized medium, FIG. 5B shows a magnetization state at the time of transferring signals from a master medium, and FIG. 5C shows a magnetization state of a medium after signal transfer.

FIG. 5A shows a magnetization state of a medium 1 which has been initialized in a method described in First Embodiment. Initialization magnetization H1i is formed at the first magnetic film 11 in a perpendicular direction of the substrate 10, while initialization magnetization H2i is formed at the second magnetic film 12 in a perpendicular direction of the substrate 10. As mentioned above, the direction of the initialization magnetization H1i and the direction of the initialization magnetization H2i accord with each other. It should be noted that a medium 1 can be manufactured with high efficiency when initializing a plurality of mediums 1 simultaneously.

Next, using an initialized medium 1 as a slave medium, a signal pattern (mark pattern) is recorded in (transferred to) the slave medium from the master mediums 21 and 22. FIG. 5B shows a state where a first master medium 21 and a second master medium 22 respectively face with the surface of the first magnetic film 11 and the surface of the second magnetic film 12, and a magnetic field for signal transfer Hm as an external magnetic field is applied to transfer signals to the initialized medium 1. The first master medium 21 is arranged in contact with or in proximity to the first magnetic film 11 so that a sufficient amount of magnetic field lines go through the first magnetic film. Likewise, the second master medium 22 is arranged in contact with or in proximity to the second magnetic film 12. The first master medium 21 is provided with a magnetic material area for signal transfer 21m which is formed to face the medium 1, the area 21m corresponding to a signal pattern to be transferred to and written on the surface of a substrate 21b which is made of the same non-magnetic material as the substrate 10. Like the first master medium 21, the second master medium 22 is provided with a magnetic material area for signal transfer 22m which is formed to face the medium 1, the area 22m corresponding to a signal pattern to be transferred to and written on the surface of a substrate 22b. The signal patterns (magnetic areas for signal transfer 21m and 22m) formed in the first master medium 21 and the second master medium 22 are respectively transferred to the first magnetic film 11 and the second magnetic film 12 which each master medium faces.

Through the magnetic material areas for signal transfer 21m and 22m, which are made of, for example, ferromagnetic material having perpendicular magnetization or soft magnetic material, magnetic field lines generated by a magnetic field for signal transfer Hm go in a converged manner. Accordingly, the magnetic material areas for signal transfer 21m and 22m respectively form magnetic material magnetization for signal transfer Hm21 and Hm22 which are indicated by arrows relieved in white in the figure. The magnetic material magnetization for signal transfer Hm21 and Hm22 allow magnetic field lines go through them, without power reduced, to the first magnetic film 11 and the second magnetic film 12 arranged in contact with or in proximity to them, so that mark magnetization H1m and H2m indicated by arrows relieved in white are formed respectively in the first magnetic film 11 and the second magnetic film 12, i.e., the signal transfer is performed. Since the magnetic material areas for signal transfer 21m and 22m are made of ferromagnetic material or soft magnetic material, magnetic field lines go through them in a converged manner. Consequently, precise signal transfer can be realized. In areas where magnetic material areas for signal transfer 21m and 22m do not exist, magnetic field lines strong enough for signal transfer do not exist and initialization magnetization H1i and H2i keep the same strength as generated at is the time of initialization.

A signal pattern to be transferred includes, for example, servo signals used for tracking control such as a cylinder number and a sector number in a magnetic disk, and pre-format signals such as a security signal. In particular, when transferring pre-format signals, a pre-format signal on one side of a magnetic disk is a mirror image of a pre-format signal on the other side of the disk. Consequently, a signal pattern of the first master medium 21 can be positioned as a mirror image of a signal pattern of the second master medium 22, so that a mirror image of any one of data can be used as the other data. In other words, master mediums (first master medium 21 and second master medium 22) having patterns, each one of which is a mirror image of the other, can be used. Even when a bit density is raised and it is required for precise signal transfer to fine adjust sizes of marks (magnetic material areas for signal transfer 21m and 22m) on master mediums on the basis of existence or absence of surrounding marks (i.e. signals), sizes of surrounding marks or distances from surrounding marks, a mirror image of generated correction data of any one of the first master medium 21 and the second master medium 22 can be used as correction data for the other master medium. Consequently, correction data needs to be generated only one time, and thereby manufacture of master mediums can be simple and easy. In other words, signals can be easily transferred to a medium.

FIG. 5C shows a magnetization state of a medium after signal transfer. With respect to a perpendicular direction of the substrate 10, the direction of the mark magnetization H1m at the first magnetic film 11 and the direction of the mark magnetization H2m at the second magnetic film 12 accord with each other. With respect to a perpendicular direction of the substrate 10, the direction of the initialization magnetization H1i and the direction of the initialization magnetization H2i accord with each other, and are opposite to the direction of the mark magnetization H1m and H2m.

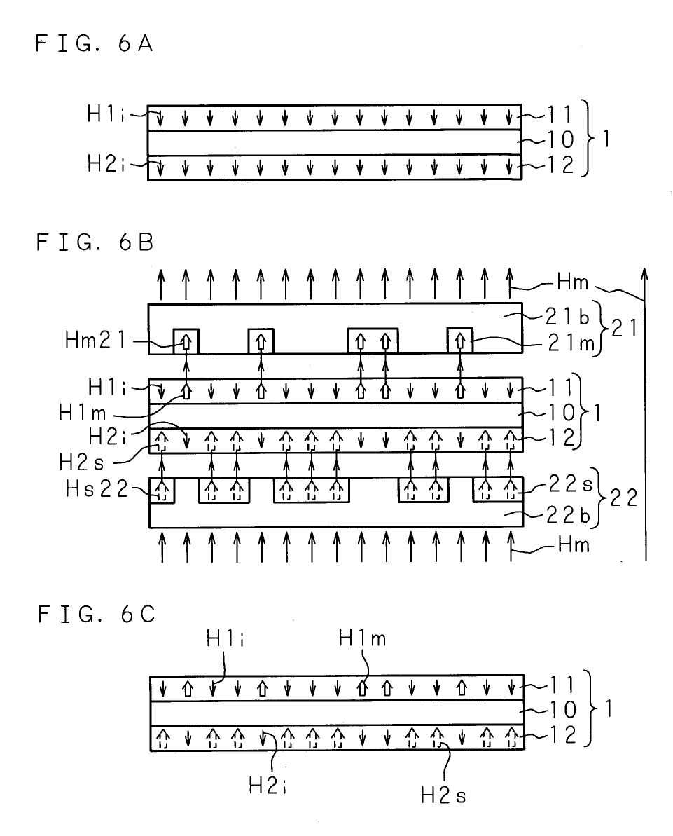

FIGS. 6A through 6C are explanatory views for showing another method for transferring a signal to a medium, to be compared with the method for transferring a signal to a medium shown in FIGS. 5A through 5C. FIG. 6A shows a magnetization state of an initialized medium, FIG. 6B shows a magnetization state at the time of transferring signals from a master medium, and FIG. 6C shows a magnetization state of a medium after signal transfer. Since FIG. 6A shows the same magnetization state as that of FIG. 5A, the explanation thereof is omitted here.

FIG. 6B shows the same magnetization state as that of FIG. 5B, except for the point that a signal pattern (mark pattern) is transferred from the first master medium 21 while a space pattern (areas other than the mark pattern) are transferred from the second master medium 22. In the first master medium 21, magnetic material area for signal transfer 21m is formed on the surface facing the medium 1 in correspondence to signals (marks) to be transferred and written, while in the second master medium 22, magnetic material area for signal transfer 22s is formed on the surface facing the medium 1 in correspondence to spaces to be transferred and written. In other words, the first master medium 21 is used for transferring signals (marks), while the second master medium 22 is used for transferring spaces. Through the magnetic material areas for signal transfer 21m and 22s, which are made of, for example, ferromagnetic material or soft magnetic material, magnetic field lines generated by a magnetic field for signal transfer Hm go in a converged manner. Accordingly, the magnetic material areas for signal transfer 21m and 22s respectively form magnetic material magnetization for signal transfer Hm21 and Hm22. Since the magnetic material magnetization for signal transfer Hm21 and Hm22 allow magnetic field lines go through them, without power reduced, to the first magnetic film 11 and the second magnetic film 12 arranged in contact with or in proximity to them, mark magnetization H1m is formed at the first magnetic film 11 and space magnetization H2s is formed at the second magnetic film 12, i.e., signal transfer is performed.

Signal transfer is performed with magnetic field lines being converged at the magnetic material areas for signal transfer 21m and 22s. In particular, when soft magnetic material is used for these areas, narrower transfer areas are preferable to maintain the density of magnetic field lines. However, for pit position recording such as recording a cylinder number in a magnetic disk, spaces hold larger dimensions than marks. Consequently, for such kind of recording, the above-mentioned method in which marks are transferred to one side of a medium and spaces are transferred to the other side of the medium is not preferable since transfer areas are wide. Moreover, by this method, a pattern of the first master medium 21 and a pattern of the second master medium 22 (positions and sizes of the magnetic material areas for signal transfer 21m and 22s) are different from each other. As a result, when fine adjustment of marks is required, fine correction data has to be first generated for each of the first master medium 21 and the second master medium 22, and therefore, manufacture of master mediums becomes more complicated. Consequently, this method is not preferable in comparison with the Third Embodiment shown in FIGS. 5A through 5C.

FIG. 6C shows the same state as that of FIG. 5C, except for the following point. The direction of the initialization magnetization H1i of the first magnetic film 11 and the direction of the corresponding space magnetization H2s of the second magnetic film 12 are opposite to each other with regard to a perpendicular direction of the substrate 10. Likewise, the direction of the mark magnetization H1m of the first magnetic film 11 and the direction of the corresponding initialization magnetization H2i of the second magnetic film 12 are opposite to each other with regard to a perpendicular direction of the substrate 10. This case is, as mentioned with reference to FIG. 6B, not preferable since transfer areas are wide.

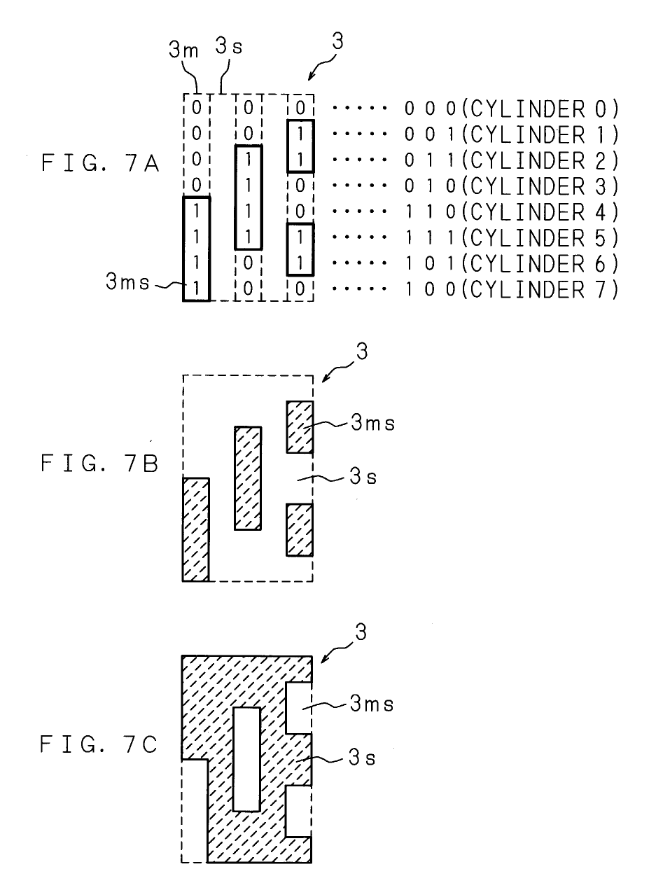

FIGS. 7A through 7C are explanatory views for showing transfer states of cylinder numbers at a magnetic disk to which the present invention has been applied. FIG. 7A shows a code indicated by a gray code as a pattern at the surface of a medium, FIG. 7B shows a mark pattern (signal pattern) of a master medium used for transferring cylinder numbers as a mark pattern and FIG. 7C shows a space pattern of a master medium used for transferring cylinder numbers as a space pattern.

FIG. 7A shows gray codes which correspond to cylinder numbers 0 through 7. A gray code “000” is applied to the cylinder number 0, a gray code “001” to the cylinder number 1, a gray code “011” to the cylinder number 2, . . . , and a gray code “100” is applied to the cylinder number 7. When these are indicated by a signal pattern on a medium, the signal pattern includes marks and spaces as shown in the cylinder number pattern 3, since cylinder numbers are recorded by pit position recording. In other words, the cylinder number pattern 3 is composed of a mark pattern 3ms corresponding to a signal “1”, a mark area 3m including an area corresponding to a signal “0”, and a space pattern 3s. A magnetization direction of the area corresponding to a signal “0” and a magnetization direction of the space pattern 3s accord with each other, and thereby these areas can be handled together as a space pattern 3s at the time of signal transfer.

FIG. 7B shows a state where cylinder numbers are transferred as a mark pattern (signal pattern). It is shown that marks 3ms to be transferred have smaller dimensions than a space pattern 3s. FIG. 7C shows a state where cylinder numbers are transferred as a space pattern. It is shown that an inversion area of a mark pattern 3ms (space pattern 3s) has larger dimensions than the mark pattern 3ms. It has been already stated that a mark pattern transfer with which transfer dimensions can be reduced is more preferable than a space pattern transfer.

Fourth Embodiment

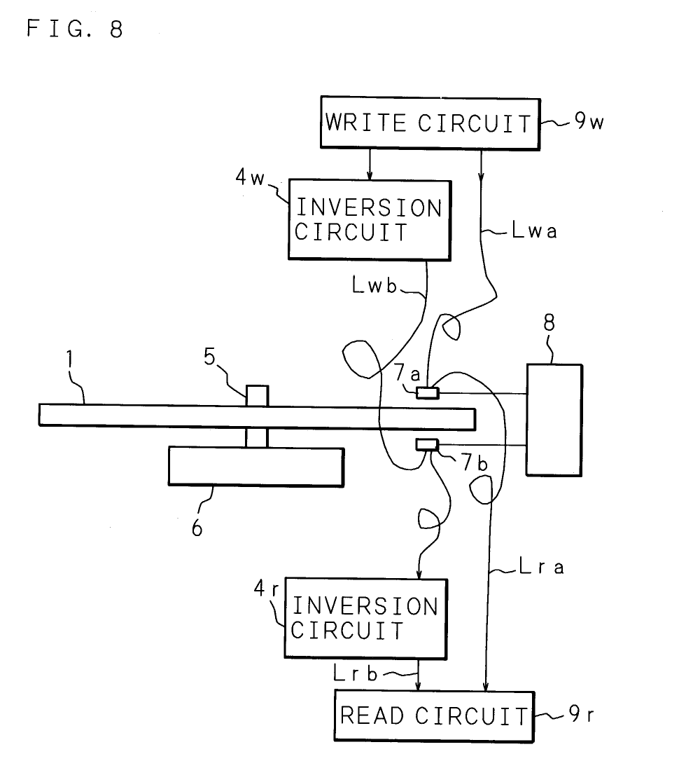

FIG. 8 is a schematic view of an apparatus for processing a signal of a medium according to the present invention. In the apparatus for processing a signal of a medium, a medium (double-sided perpendicular magnet recording medium) 1 is fixed at a rotary shaft 5 and is driven to rotate by a spindle motor 6. Sliding magnetic heads 7a and 7b are respectively arranged to face respective sides of the medium 1 to write/read magnetization in/from a first magnetic film 11 and a second magnetic film 12 (see FIGS. 3A and 3B) which are formed on the respective sides of the medium 1. A seek mechanism 8 controls positions of the sliding magnetic heads 7a and 7b at the surface of the medium 1. Each of the sliding magnetic heads 7a and 7b is provided with a write head and a read head (which are not illustrated in the figure). The write heads are connected with a write circuit 9w and the read heads are connected with a read circuit 9r, so as to respectively construct signal write means and signal read means.

A write signal line Lwa connects the write circuit 9w and the write head in the sliding magnetic head 7a, while a write signal line Lwb connects the write circuit 9w and the write head in the sliding magnetic head 7b. Signals to be written are sent from the write circuit 9w through the write signal lines Lwa and Lwb to respective write heads, to write signals in the medium 1 (first magnetic film 11 and second magnetic film 12). A read signal line Lra connects the read circuit 9r and the read head in the sliding magnetic head 7a, while a read signal line Lrb connects the read circuit 9r and the read head in the sliding magnetic head 7b. Read signals are sent from respective read heads through the read signal lines Lra and Lrb to the read circuit 9r, to read signals from the medium 1 (first magnetic film 11 and second magnetic film 12).

Magnetization directions of signals (marks) at respective sides of the medium 1 (first magnetic film 11 and second magnetic film 12) are, as described in First Embodiment (FIGS. 3A and 3B) and the like, different from each other when the surface is seen from the outside. Consequently, by connecting an inversion circuit 4w with any one of the write signal lines Lwa and Lwb, for example, the write signal line Lwb, polarity of marks (signals to be written) which are sent through the write signal line Lwb to be written on the medium 1 (second magnetic film 12) is inverted, so as to accord with the polarity of marks (signals to be written) which are sent through the write signal line Lwa to be written on the medium 1 (first magnetic film 11). Likewise, by connecting an inversion circuit 4r with any one of the read signal lines Lra and Lrb, for example, the read signal line Lrb, polarity of marks (read signals) which are read from the medium 1 (second magnetic film 12) and sent through the read signal line Lrb is inverted, so as to accord with the polarity of marks (read signals) which are read from the medium 1 (first magnetic film 11) and sent through the read signal line Lra. When signals at both sides of the medium 1 which have different polarities from each other when seen from the outside are transformed to have the same polarity as described above, the write circuit 9w and the read circuit 9r can use the same signal processing, and thereby signals can be written and read easily. It should be noted that, though the above description has explained a state where the inversion circuits 4w and 4r are arranged in the write signal line Lwb and the read signal line Lrb which correspond to the lower side of the medium 1 (second magnetic film 12), the inversion circuits 4w and 4r may be arranged in the write signal line Lwa and read signal line Lra which correspond to the upper side of the medium (first magnetic film 11). In other words, polarity inversion may be performed for any side of the medium as long as the same polarity is detected from both sides of the medium 1. It should be also noted that the apparatus for processing a signal of a medium may be provided with only one of the signal write means and signal read means. Moreover, it should be understood that like inversion circuits can be also incorporated in an apparatus for processing signals of a plurality of mediums 1.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A method for initializing a double-sided perpendicular magnetic recording medium which includes: a substrate; a first magnetic film formed on a first surface of the substrate; and a second magnetic film formed on a second surface of the substrate on the other side of the first surface, comprising:
an initialization step of applying an initialization magnetic field in a direction crossing surfaces of the substrate to initialize the first magnetic film and the second magnetic film simultaneously,
whereby a direction of initialization magnetization of the first magnetic film and a direction of initialization magnetization of the second magnetic film accord with each other, with regard to the direction crossing surfaces of the substrate.

2. The method for initializing a magnetic recording medium according to claim 1, further comprising a step of superposing a plurality of double-sided perpendicular magnetic recording mediums,
wherein the initialization magnetic field in the initialization step is applied in a superposition direction of the mediums so as to initialize the double-sided perpendicular magnetic recording mediums simultaneously.

3. A method for transferring a signal pattern to a double-sided perpendicular magnetic recording medium which includes: a substrate; a first magnetic film formed on a first surface of the substrate; and a second magnetic film formed on a second surface of the substrate on the other side of the first surface, comprising the steps of:
arranging a first master medium, which has a magnetic material area corresponding to a signal pattern to be transferred, superposed in contact with or in proximity to the first magnetic film;
arranging a second master medium, which has a magnetic material area corresponding to a signal pattern to be transferred, superposed in contact with or in proximity to the second magnetic film; and
applying a magnetic field for signal transfer in a direction crossing the first master medium, double-sided perpendicular magnetic recording medium and second master medium, to transfer the signal pattern of the first master medium to the first magnetic film and the signal pattern of the second master medium to the second magnetic film.

4. The method for transferring a signal to a magnetic recording medium according to claim 3, wherein the double-sided perpendicular magnetic recording medium is such initialized in advance that a direction of initialization magnetization of the first magnetic film and a direction of initialization magnetization of the second magnetic film accord with each other with regard to a direction crossing surfaces of the substrate.

5. The method for transferring a signal to a magnetic recording medium according to claim 4, wherein the magnetic material area is made of any one of soft magnetic material and perpendicular ferromagnetic material.

6. The method for transferring a signal to a magnetic recording medium according to claim 4, wherein each one of the signal pattern in the first master medium and the signal pattern in the second master medium is a mirror image of the other.

7. The method for transferring a signal to a magnetic recording medium according to claim 4, wherein the signal pattern to be transferred is a pattern of a pre-format signal of the double-sided perpendicular magnetic recording medium.

8. The method for transferring a signal to a magnetic recording medium according to claim 3, wherein the magnetic material area is made of any one of soft magnetic material and perpendicular ferromagnetic material.

9. The method for transferring a signal to a magnetic recording medium according to claim 3, wherein each one of the signal pattern in the first master medium and the signal pattern in the second master medium is a mirror image of the other.

10. The method for transferring a signal to a magnetic recording medium according to claim 3, wherein the signal pattern to be transferred is a pattern of a pre-format signal of the double-sided perpendicular magnetic recording medium.

11. An apparatus for processing a signal of a double-sided perpendicular magnetic recording medium in which directions of initialization magnetization of a first magnetic film and a second magnetic film formed on respective sides of the substrate accord with each other with regard to a direction crossing surfaces of the substrate, comprising at least one of:
a signal write unit for writing signals in the first magnetic film and the second magnetic film, which includes an inversion circuit for inverting polarity of any one of a signal to be written in the first magnetic film and a signal to be written in the second magnetic film; and
a signal read unit for reading signals from the first magnetic film and the second magnetic film, which includes an inversion circuit for inverting polarity of any one of a signal read from the first magnetic film and a signal read from the second magnetic film.

12. A double-sided perpendicular magnetic recording medium comprising:
a substrate;
a first magnetic film formed on a first surface of the substrate; and
a second magnetic film formed on a second surface of the substrate on the other side of the first surface,
wherein a direction of initialization magnetization of the first magnetic film and a direction of initialization magnetization of the second magnetic film accord with each other, with regard to a direction crossing surfaces of the substrate.
